(19) United States
(12) Patent Application Publication
(10) Pub. No.: US 2024/0427478 A1
(43) Pub. Date: Dec. 26, 2024

(54) LOCATION AWARE DIGITAL SIGN THAT DISPLAYS KEY PERFORMANCE INDICATORS OF A BUILDING THAT ARE TAILORED TO THE CURRENT LOCATION OF THE DIGITAL SIGN WITHIN THE BUILDING

(71) Applicant: Honeywell International Inc., Charlotte, NC (US)

(72) Inventors: Dani Stern, Seattle, WA (US); Jayaprakash Meruva, Bangalore (IN); Nitant Kulshrestha, Bengaluru (IN); Rajiv Reddy V S, Bangalore (IN)

(21) Appl. No.: 18/505,103

(22) Filed: Nov. 8, 2023

(30) Foreign Application Priority Data
Jun. 23, 2023 (IN) 202311041973

(51) Int. Cl. G06F 3/04842; H04W 4/021

(52) U.S. Cl. CPC G06F 3/04842; H04W 4/021

(57) ABSTRACT

A digital sign may be used in a building. The digital sign includes a housing, a display housed by the housing, a wireless interface that supports one or more wireless protocols, and a controller that is housed by the housing and is operatively coupled to the display and the wireless interface. The controller is configured to identify a current location of the digital sign in the building, obtain via the wireless interface one or more key performance indicators of the building that are dependent on the current location of the digital sign in the building, and display on the display the one or more key performance indicators of the building that are dependent on the current location of the digital sign in the building.

### RELATED APPLICATIONS

This application claims the benefit of Indian Provisional Patent Application Number 202311041973, filed Jun. 23, 2023, which application is incorporated by reference herein.

### TECHNICAL FIELD

The present disclosure relates generally to methods and systems for configuring customized digital signs and more particularly to methods and systems for configuring customized location-specific digital signs for display in a multi-tenant building.

### BACKGROUND

A number of building spaces employ energy savings techniques in order to achieve their sustainability goals. Many building owners want to publicize the results of these energy savings technologies and their progress towards meeting their sustainability goals. Many buildings include multiple tenants, which can complicate ascribing energy consumption to specific tenants. Moreover, individual tenants may have differing priorities as to what information they want displayed for their individual spaces. What would be desirable are methods and systems for meeting various tenant's needs for determining and displaying individualized information pertaining to their sustainability goals.

### SUMMARY

The present disclosure relates generally to methods and systems for configuring customized digital signs and more particularly to methods and systems for configuring customized location-specific digital signs for display in a multi-tenant building. An example may be found in a digital sign for use in a building. The digital sign includes a housing and a displayed housed by the housing such that the display is viewable from outside of the housing. A wireless interface supports one or more wireless protocols. A controller is housed by the housing and is operatively coupled to the display and the wireless interface. The controller is configured to identify a current location of the digital sign in the building, obtain via the wireless interface one or more key performance indicators of the building that are dependent on the current location of the digital sign in the building, and display on the display the one or more key performance indicators of the building that are dependent on the current location of the digital sign in the building.

Another example may be found in a method for operating a digital sign device in a building. The method includes identifying each of a plurality of predefined spaces of the building and storing a digital sign template for each of the plurality of predefined spaces of the building. A current location of the digital sign device in the building is dynamically determined using a location service of the digital sign device. A determination is made as to which of the plurality of predefined spaces of the building corresponds to the current location of the digital sign device. The digital sign template that corresponds to the predefined space of the plurality of predefined spaces of the building that is associated with the current location of the digital sign device is displayed on the digital sign device.

Another example may be found in a method for operating a digital sign device in a building that includes a plurality of tenant spaces. The method includes placing the digital sign device at a first location in the building. A determination is made as to a first current location of the digital sign device in the building that corresponds to the first location based at least in part on communication between the digital sign device and one or more indoor location devices in the building. A determination is made as to which of the plurality of tenant spaces of the building corresponds to the first current location of the digital sign device. Information that corresponds to the tenant space of the plurality of tenant spaces that corresponds to the first current location of the digital sign device is displayed on the digital sign device. The digital sign device is placed at a second location in the building that is different from the first location and a second current location of the digital sign device in the building is determined based at least in part on communication between the digital sign device and one or more indoor location devices in the building. A determination is made as to which of the plurality of tenant spaces of the plurality of tenant spaces corresponds to the second current location of the digital sign device. Information that corresponds to the tenant space of the plurality of tenant spaces that corresponds to the second current location of the digital sign device is displayed on the digital sign device.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system for customizing a digital sign for display on a display device;

FIG. 2 is a schematic block diagram showing an illustrative digital display device;

FIGS. 3A, 3B and 3C are flow diagrams that together show an illustrative method for configuring a customized digital display sign for display on a display device;

FIG. 4 is a flow diagram showing an illustrative method for configuring a customized digital display sign for display on a display device;

FIG. 5 is a flow diagram showing an illustrative method for operating a digital sign device;

FIG. 6 is a flow diagram showing an illustrative method for operating a digital sign device;

FIG. 7 is a schematic block diagram showing an illustrative digital signage architecture;

FIG. 8 is a schematic block diagram showing an illustrative digital signage integration architecture;

FIG. 9 is a screen shot showing an illustrative digital signature configurator;

FIG. 10 is a screen shot showing an illustrative digital signature management user interface;

FIGS. 11A and 11B are screen shots showing illustrative digital signs that may be displayed;

FIGS. 12A, 12b and 12C are screen shots showing illustrative digital signs that may be displayed;

FIG. 13 is a schematic block diagram showing an illustrative tenant level energy segregation process;

FIG. 14 is a screen shot showing an illustrative meter mapping screen;

FIG. 15 is a table providing options for determining tenant-level energy consumption; and

FIG. 16 is a schematic block diagram showing chiller energy sharing between tenants.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

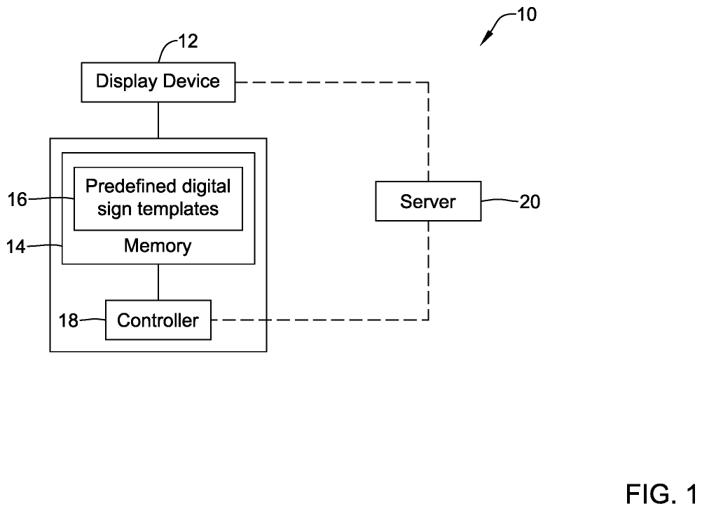

FIG. 1 is a schematic block diagram showing an illustrative system 10 for configuring a customized digital sign for display on a display device 12. The display device 12 may be located within a particular tenant space of a multi-tenant building, for example. In some instances, the display device 12 may be configured to be located within any of a variety of different tenant spaces within the multi-tenant building. In some instances, the display device 12 may include a display screen that is able to display a customized digital display. The display device 12 may be a tablet, for example, or perhaps a laptop computer. The display device 12 may be a smartphone, for example.

The illustrative system 10 includes a memory 14 that is configured to store a plurality of predefined digital sign templates 16. In some instances, each of the predefined digital sign templates 16 may reference one or more energy consumption Key Performance Indicators (KPIs). In some instances, at least some of the predefined digital sign templates 16 may additionally reference other KPIs that are not directly related to energy consumption. In some instances, the information displayed in each of the predefined digital sign templates 16 may vary from tenant to tenant, for example. The system 10 includes a controller 18 that is operatively coupled to the memory 14. In some instances, the system 10 may include, or may be in communication with, a server 20. The server 20 may be remotely located, away from the system 10. In some instances, part of the system 10 may manifested within the server 20. The server 20 may be a cloud-based server, for example. In some instances, the predefined digital sign templates 16 may be stored by the server 20, and downloaded when appropriate to the system 10.

In the example shown, the controller 18 is configured to receive a selection of one of the plurality of predefined digital sign templates 16 for the particular tenant space and to determine a current value for each of the one or more energy consumption KPIs referenced by the selected predefined digital sign template, wherein the current value for each of the one or more energy consumption KPIs corresponding to energy consumption of the multi-tenant building that is attributable to the particular tenant space. The controller 18 is configured to display the selected predefined digital sign template on the display device 12 in the particular tenant space with the current value of the one or more energy consumption KPIs referenced by the selected predefined digital sign template. In some instances, after receiving the selection of one of the plurality of predefined digital sign templates 16 for the particular tenant space, the controller 18 may be configured to send a registration code to a user associated with the tenant space (e.g. via an email, SMS message or other communication), receive the registration code from the display device in the particular tenant space (entered by the user into the display device), and after receive the registration code, display the selected predefined digital sign template on the display device in the particular tenant space.

In some instances, the controller 18 may be configured to determine the current value for each of the one or more energy consumption KPIs referenced by the selected predefined digital sign template 16 by automatically allocating part of the energy consumption of the multi-tenant building to the particular tenant space. In some instances, the controller 18 may be configured to determine the current values for each of the one or more energy consumption KPIs referenced by the selected predefined digital sign template 16 based at least in part on one or more points associated with energy consumption of the multi-tenant building. The one or more points associated with energy consumption of the multi-tenant building may include one or more points associated with one or more energy meters and/or sub-meters of the multi-tenant building, and/or one or more control points associated with controlling an operating state of one or more of the pieces of energy consuming equipment in the multi-tenant building.

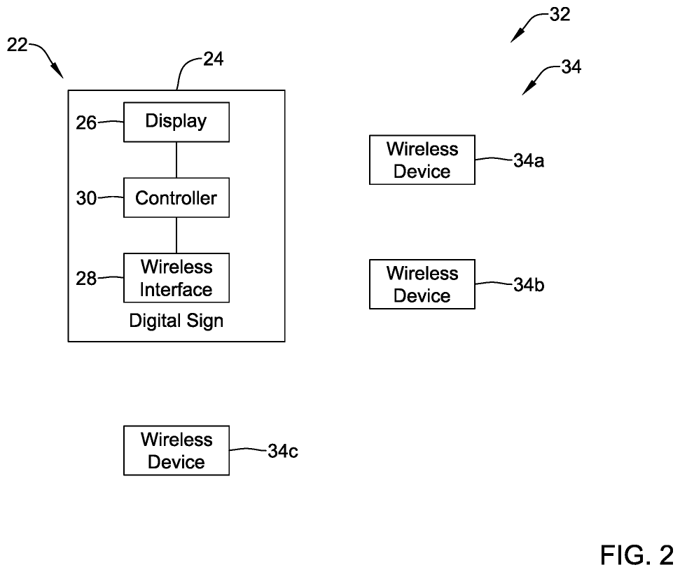

FIG. 2 is a schematic block diagram showing an illustrative digital display device 22. The digital display device 22 may be considered as being an example of the display device 12 shown in FIG. 1. The digital display device 22 includes a housing 24 and a display 26 that is housed by the housing 24 such that the display 26 is viewable from outside of the housing 24. The illustrative digital display device 22 includes a wireless interface 28 that supports one or more wireless protocols. A controller 30 is housed by the housing 24 and is operatively coupled to the display 26 and to the wireless interface 28. In some cases, the controller 30 is configured to identify a current location of the digital sign in the building and to obtain via the wireless interface 28 one or more key performance indicators of the building that are dependent on or associated with the current location of the digital display device in the building (e.g. associated with the tenant space in which the digital display device is currently located). In some instances, the wireless interface 28 may receive the one or more key performance indicators from the server 20 shown in FIG. 1.

In some instances, the current location of the digital sign may correspond to a particular tenant space of a plurality of tenant spaces in the building. The one or more key performance indicators that are displayed on the display 26 may include one or more of a reduction in energy consumption of the particular tenant space relative to a baseline energy consumption for the particular tenant space, a reduction in energy costs associated with the particular tenant space relative to a baseline energy cost for the particular tenant space, or a reduction in carbon footprint associated with the particular tenant space relative to a baseline carbon footprint for the particular tenant space. In some instances, the one or more key performance indicators that are displayed on the display 26 may include one or more of a current occupancy count of the particular tenant space or a healthy building score for the particular tenant space, wherein the healthy building score is dependent on one or more of the current occupancy count of the particular tenant space, one or more current air quality parameters associated with the particular tenant space, and one or more current behaviors of occupants of the particular tenant space. The controller 30 is configured to display on the display 26 the one or more key performance indicators of the building that are dependent on the current location of the digital sign in the building.

In some instances, the controller 30 may be configured to identify the current location of the digital sign in the building using an indoor positioning system 32 that is associated with the building. The indoor positioning system 32 may include a plurality of wireless devices 34, individually labeled as 34a, 34b and 34c. While a total of three wireless devices 34 are shown, this is merely illustrative, as the indoor positioning system 32 may include any number of wireless devices 34. Each of the wireless devices 34 may be a stand-alone device, such as a WiFi access point or a beacon. In some instances, at least some of the wireless devices 34 may be part of a larger device, such as a sensor or a thermostat that includes wireless capability.

In some instances, the wireless devices 34 may be configured to transmit over the same wireless protocol as that used by the wireless interface 28 of the digital display device 22. In some instances, each of the wireless devices 34 may be WiFi access points that are each positioned at a different known location in the building. The wireless interface 28 of the digital display device 22 may be configured to communicate with one or more in-range WiFi access points depending on the current location of the digital display device 22 within the building, and the current location of the digital display device 22 may be identified based at least in part on an identity and location of the one or more in-range WiFi access points.

In some instances, each of the wireless devices 34 are a beacon, with each beacon positioned at a different known location in the building. The wireless interface 28 of the digital display device 22 may be configured to communicate with one or more in-range beacons depending on the current location of the digital display device 22 within the building, and the current location of the digital display device 22 may be identified based at least in part on an identity and location of the one or more in-range beacons. In some instances, the beacons may be Bluetooth beacons, WiFi access points and/or any other suitable beacon. In some instances, the controller 30 may be configured to triangulate the current location of the digital sign in the building based on the signal strength from each of the in-range beacons and the known location of each of the in-range beacons.

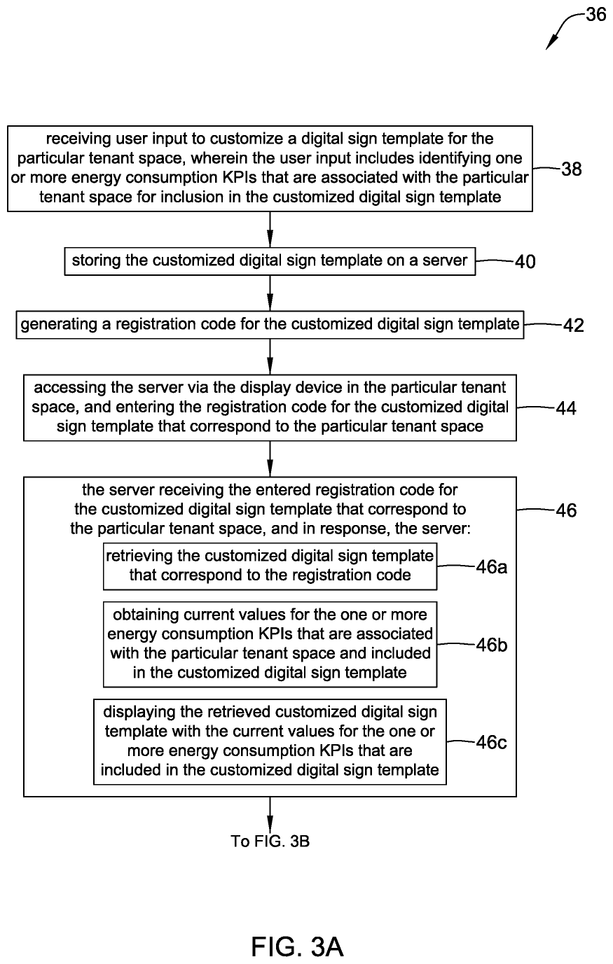

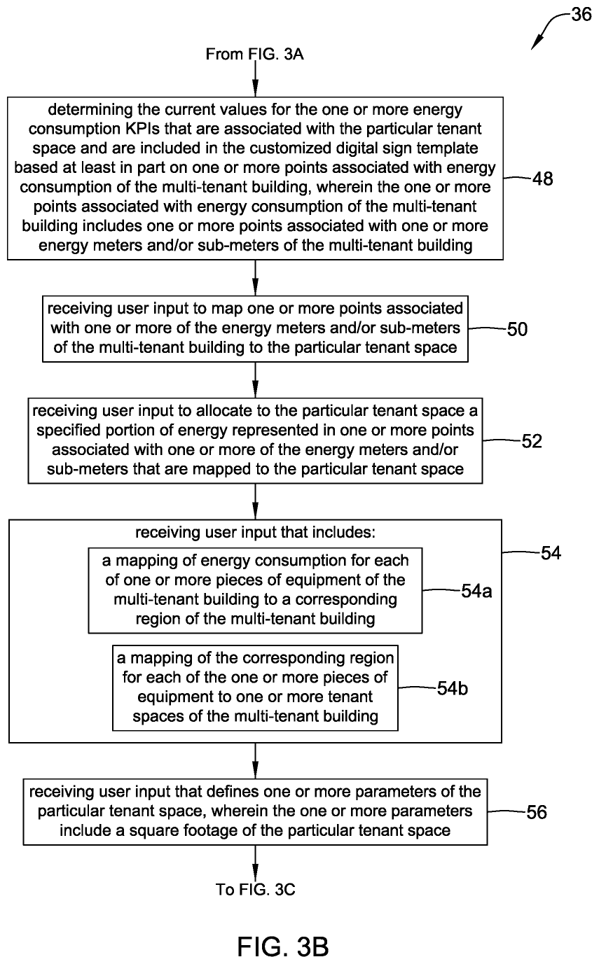

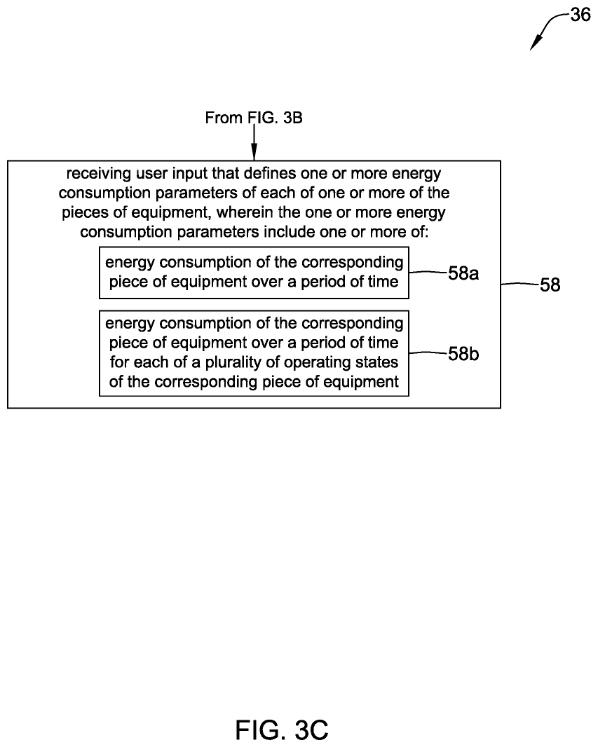

FIGS. 3A, 3B and 3C are flow diagrams that together show an illustrative method 36 for configuring a customized digital sign for display on a display device (such as the display device 12 in FIG. 1 or the digital display device 22 in FIG. 2) in a particular tenant space of a multi-tenant building. The method 36 includes receiving user input to customize a digital sign template for the particular tenant space, wherein the user input includes identifying one or more energy consumption KPIs that are associated with the particular tenant space for inclusion in the customized digital sign template, as indicated at block 38. In some instances, the one or more energy consumption KPIs that are associated with the particular tenant space include one or more of a reduction in energy consumption of the particular tenant space relative to a baseline energy consumption for the particular tenant space, a reduction in energy costs associated with the particular tenant space relative to a baseline energy cost for the particular tenant space, and a reduction in carbon footprint associated with the particular tenant space relative to a baseline carbon footprint for the particular tenant space. In some cases, the baseline energy consumption, baseline energy cost and/or baseline carbon footprint may be established before one or more energy savings algorithms are applied in controlling the building, and the one or more energy consumption KPIs are determined after the one or more energy savings algorithms are applied in controlling the building. The customized digital sign template is stored on a server (such as the server 20), as indicated at block 40. In some cases, a registration code is generated for the customized digital sign template, as indicated at block 42. The registration code is communicated to a user associated with the particular tenant space. The server is accessed via the display device in the particular tenant space, and the registration code for the customized digital sign template that correspond to the particular tenant space is entered by the user associated with the particular tenant space, as indicated at block 44.

The server receives the entered registration code for the customized digital sign template that correspond to the particular tenant space, as indicated at block 46. In response to receiving the registration code, the server retrieves the customized digital sign template that correspond to the registration code (and thus the particular tenant space), as indicated at block 46a. In response to receiving the registration code, the server obtains current values for the one or more energy consumption KPIs that are associated with the particular tenant space and referenced in the customized digital sign template, as indicated at block 46b. In response to receiving the registration code, the server displays the retrieved customized digital sign template with the current values for the one or more energy consumption KPIs that are referenced in the customized digital sign template, as indicated at block 46c. In some instances, the current values of one or more of the energy consumption KPIs may be based at least in part on one or more points associated with one or more of the energy meters and/or sub-meters of the multi-tenant building that are mapped to the particular tenant space.

The method 36 continues on FIG. 3B. The current values for the one or more energy consumption KPIs that are associated with the particular tenant space and referenced in the customized digital sign template may be determined based at least in part on one or more points associated with energy consumption of the multi-tenant building, wherein the one or more points associated with energy consumption of the multi-tenant building includes one or more points associated with one or more energy meters and/or sub-meters of the multi-tenant building, as indicated at block 48. In some instances, the method 36 includes receiving user input to map one or more points associated with one or more of the energy meters and/or sub-meters of the multi-tenant building to the particular tenant space, as indicated at block 50. In some instances, the method 36 may include receiving user input to allocate to the particular tenant space a specified portion of energy represented in one or more points associated with one or more of the energy meters and/or sub-meters that are mapped to the particular tenant space, as indicated at block 52.

In some instances, the method 36 may include receiving user input, as indicated at block 54. The user input may include a mapping of energy consumption for each of one or more pieces of equipment of the multi-tenant building to a corresponding region of the multi-tenant building, as indicated at block 54a. The user input may include a mapping of the corresponding region for each of the one or more pieces of equipment to one or more tenant spaces of the multi-tenant building, as indicated at block 54b. In some instances, the method 36 may include receiving user input that defines one or more parameters of the particular tenant space, wherein the one or more parameters include a square footage of the particular tenant space, as indicated at block 56.

The method 36 continues on FIG. 3C, with receiving user input that defines one or more energy consumption parameters of each of one or more of the pieces of equipment, as indicated at block 58. The one or more energy consumption parameters may include energy consumption of the corresponding piece of equipment over a period of time, as indicated at block 58a. The one or more energy consumption parameters may include energy consumption of the corresponding piece of equipment over a period of time for each of a plurality of operating states of the corresponding piece of equipment, as indicated at block 58b. In some instances, the one or more of the points associated with energy consumption of the multi-tenant building may include one or more control points associated with controlling the operating states of one or more of the pieces of equipment (e.g. fan on/off, heating valve open/closed, cooling valve open/closed, etc.). In some instances, the one or more points associated with energy consumption of the multi-tenant building may include one or more points associated with one or more sensors of a building control system of the multi-tenant building. As an example, the one or more sensors may include one or more of a temperature sensor, a pressure sensor, a flow sensor and a magnetic field sensor.

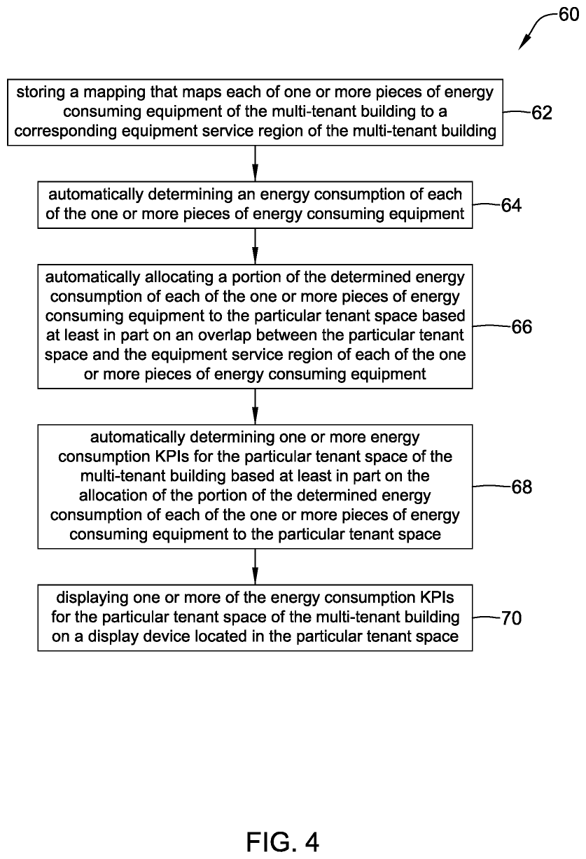

FIG. 4 is a flow diagram showing an illustrative method 60 for determining one or more energy consumption KPIs for a particular tenant space of a multi-tenant building. The method 60 includes storing a mapping that maps each of one or more pieces of energy consuming equipment of the multi-tenant building to a corresponding equipment service region of the multi-tenant building, as indicated at block 62. The method 60 includes automatically determining an energy consumption of each of the one or more pieces of energy consuming equipment, as indicated at block 64.

In some instances, automatically determining the energy consumption of each of the one or more pieces of energy consuming equipment comprises, for a piece of energy consuming equipment that is always active, multiplying a total number of hours by a known energy consumption per hour of the piece of energy consuming equipment. In some instances, automatically determining the energy consumption of each of the one or more pieces of energy consuming equipment comprises for a piece of energy consuming equipment that is either in an ON state or an OFF state, adding an energy consumed by the piece of energy consuming equipment that is in the ON state times the time that the piece of energy consuming equipment that is in the ON state plus the energy consumed while the piece of energy consuming equipment that is in the OFF state times the time that the piece of energy consuming equipment that is in the OFF state. In some instances, automatically determining the energy consumption of each of the one or more pieces of energy consuming equipment comprises, for a piece of energy consuming equipment that has three or more states, adding the energy consumed by the piece of energy consuming equipment in each of the three or more states times the time that the piece of energy consuming equipment is in each of the three or more states. In some instances, automatically determining the energy consumption of each of the one or more pieces of energy consuming equipment comprises, for a piece of energy consuming equipment that has continuously variable energy draw, adding the energy consumed by the piece of energy consuming equipment in each of a plurality of steady state conditions times the time that the piece of energy consuming equipment is in each of the plurality of steady state conditions plus the energy consumed by the piece of energy consuming equipment during one or more transient conditions when transitioning between the plurality of steady state conditions times the time that the piece of energy consuming equipment is in the corresponding transient condition. In some instances, automatically determining the energy consumption of each of the one or more pieces of energy consuming equipment may include obtaining a measure of energy consumption from one or more energy meters and/or sub-meters of the multi-tenant building.

The method 60 includes automatically allocating a portion of the determined energy consumption of each of the one or more pieces of energy consuming equipment to the particular tenant space based at least in part on an overlap (e.g. percentage) between the particular tenant space and the equipment service region of each of the one or more pieces of energy consuming equipment, as indicated at block 66. The method 60 includes automatically determining one or more energy consumption KPIs for the particular tenant space of the multi-tenant building based at least in part on the allocation of the portion of the determined energy consumption of each of the one or more pieces of energy consuming equipment to the particular tenant space, as indicated at block 68. The method 60 includes displaying one or more of the energy consumption KPIs for the particular tenant space of the multi-tenant building on a display device located in the particular tenant space, as indicated at block 70.

In some instances, the particular tenant space corresponds to a square foot tenant area, the equipment service region of a first one of the pieces of energy consuming equipment correspond to a square foot service area, and the overlap between the particular tenant space and the equipment service region of the first one of the pieces of energy consuming equipment has a square foot overlap area, wherein automatically allocating the portion of the determined energy consumption of the first one of the pieces of energy consuming equipment to the particular tenant space is based at least in part on a ratio of the square foot overlap area and the square foot service area of the first one of the pieces of energy consuming equipment. This is just an example.

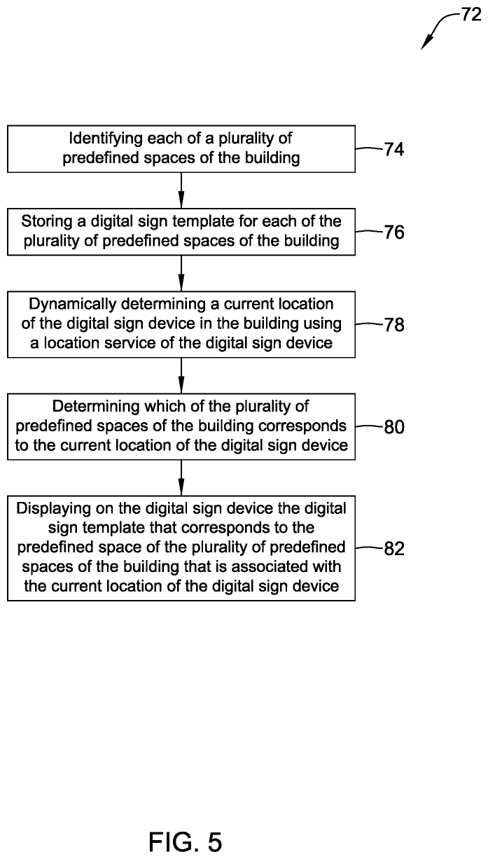

FIG. 5 is a flow diagram showing an illustrative method 72 for operating a digital sign device (such as the display device 12 of FIG. 1 or the digital display device 22 of FIG. 2) in a building. The illustrative method includes identifying each of a plurality of predefined spaces of the building, as indicated at block 74. A digital sign template is stored for each of the plurality of predefined spaces of the building, as indicated at block 76. A current location of the digital sign device in the building is dynamically determined using a location service of the digital sign device, as indicated at block 78. A determination is made as to which of the plurality of predefined spaces of the building corresponds to the current location of the digital sign device, as indicated at block 80. The digital sign template that corresponds to the predefined space of the plurality of predefined spaces of the building that is associated with the current location of the digital sign device is automatically displayed on the digital sign device, as indicated at block 82.

In some instances, each digital sign template includes one or more key performance indicators that are selected by a user for the corresponding one of the plurality of predefined spaces of the building. In some instances, a value of the one or more key performance indicators may be determined by a remote device and communicated to the digital sign device. Each of the plurality of predefined spaces of the building may correspond to a corresponding one of a plurality of tenant spaces of the building. In some instances, the one or more key performance indicators that are displayed on the digital sign device may include one or more of a reduction in energy consumption of the corresponding tenant space relative to a baseline energy consumption for the corresponding tenant space, a reduction in energy costs associated with the corresponding tenant space relative to a baseline energy cost for the corresponding tenant space, and a reduction in carbon footprint associated with the corresponding tenant space relative to a baseline carbon footprint for the corresponding tenant space. In some instances, the one or more key performance indicators that are displayed on the display may include one or more of a current occupancy count of the corresponding tenant space or a healthy building score for the corresponding tenant space, wherein the healthy building score is dependent on one or more of the current occupancy count of the corresponding tenant space, one or more current air quality parameters associated with the corresponding tenant space, and one or more current behaviors of occupants of the corresponding tenant space.

In some instances, the digital sign device may be configured to communicate with one or more indoor location devices. Based at least in part on the communication with the one or more indoor location devices, the digital sign device may be configured to determine the current location of the digital sign device in the building. As an example, the one or more indoor location devices may include WiFi access points or Bluetooth beacons, and the digital sign device may be configured to determine the current location of the digital sign device via signal strength and/or triangularization.

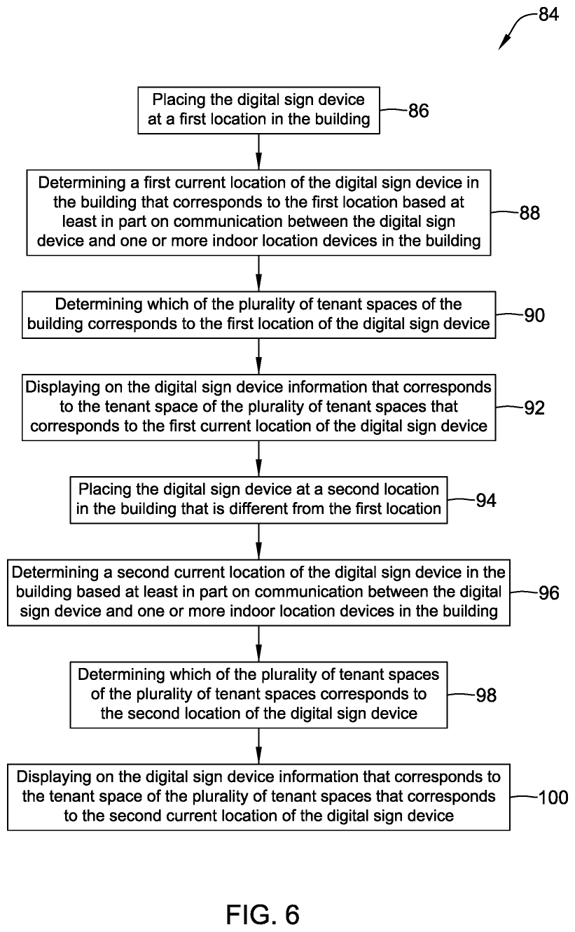

FIG. 6 is a flow diagram showing an illustrative method 84 for operating a digital sign device (such as the display device 12 of FIG. 1 or the digital display device 22 of FIG. 2) in a building that includes a plurality of tenant spaces. The illustrative method 84 includes placing the digital sign device at a first location in the building, as indicated at block 86. A determination is made of a first current location of the digital sign device in the building that corresponds to the first location based at least in part on communication between the digital sign device and one or more indoor location devices in the building, as indicated at block 88. A determination is made as to which of the plurality of tenant spaces of the building corresponds to the first current location of the digital sign device, as indicated at block 90. Information that corresponds to the tenant space of the plurality of tenant spaces that corresponds to the first current location of the digital sign device is automatically selected and then displayed on the digital sign device, as indicated at block 92.

The digital sign device is then placed at a second location in the building that is different from the first location, as indicated at block 94. A determination is made of a second current location of the digital sign device in the building based at least in part on communication between the digital sign device and one or more indoor location devices in the building, as indicated at block 96. A determination is made as to which of the plurality of tenant spaces of the plurality of tenant spaces corresponds to the second current location of the digital sign device, as indicated at block 98. Information that corresponds to the tenant space of the plurality of tenant spaces that corresponds to the second current location of the digital sign device is automatically selected and displayed on the digital sign device, as indicated at block 100.

In some instances, the information that corresponds to the tenant space of the plurality of tenant spaces that corresponds to the first current location of the digital sign device includes one or more key performance indicators that are associated with the tenant space of the plurality of tenant spaces that corresponds to the first current location of the digital sign device and the information that corresponds to the tenant space of the plurality of tenant spaces that corresponds to the second current location of the digital sign device includes one or more key performance indicators that are associated with the tenant space of the plurality of tenant spaces that corresponds to the second current location of the digital sign device. In some instances, the one or more key performance indicators that are associated with the tenant space of the plurality of tenant spaces that corresponds to the first current location of the digital sign device are different from the one or more key performance indicators that are associated with the tenant space of the plurality of tenant spaces that corresponds to the second current location of the digital sign device. In some cases, the one or more key performance indicators that are associated with the tenant space of the plurality of tenant spaces that corresponds to the first current location of the digital sign device and/or to the second current location of the digital sign device includes one or more of a reduction in energy consumption of the corresponding tenant space relative to a baseline energy consumption for the corresponding tenant space, a reduction in energy costs associated with the corresponding tenant space relative to a baseline energy cost for the corresponding tenant space, and a reduction in carbon footprint associated with the corresponding tenant space relative to a baseline carbon footprint for the corresponding tenant space. These are just examples.

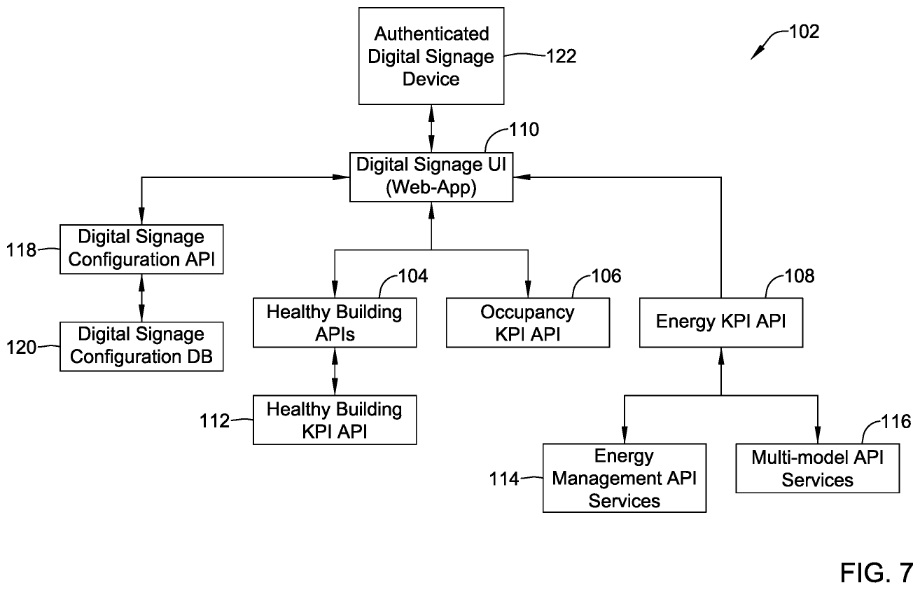

FIG. 7 is a schematic block diagram showing an illustrative digital signage architecture 102. Starting at the bottom of FIG. 7, a number of APIs (Application Programming Interfaces) such as a Healthy Building APIs block 104, an Occupancy KPI API block 106 and an Energy KPI API block 108 provide data up to a digital signage UI (User Interface) 110, which may for example be web-based. In the example shown, the Healthy Building APIs block 104 is in communication with a Healthy Building KPI (Key Performance Indicators) API block 112, and the Energy KPI API block 108 is in communication with an Energy Management API Service block 114 as well as a Multi-Mode API Services block 116. A Digital Signage Configuration API block 118 communicates with the Digital Signage UI 110 and with a Digital Signage Configuration DB (Data Base) 120. The Digital Signage Configuration API block 118 allows for configuration or customization of the digital signage, while the Digital Signage Configuration DB 120 stores configuration information. In some cases, the Digital Signage Configuration DB 120 stores a number of predetermined digital signage templates to help define digital signage for a wide range of tenants. The Digital Signage UI 110 provides dashboards and/or information to an Authenticated Digital Signage Device 122, which displays the dashboards or other information in accordance with the configuration that was set up. The Authenticated Digital Signage Device 122 may be considered as being an example of the display device 12 of FIG. 1 or the digital display device 22 of FIG. 2.

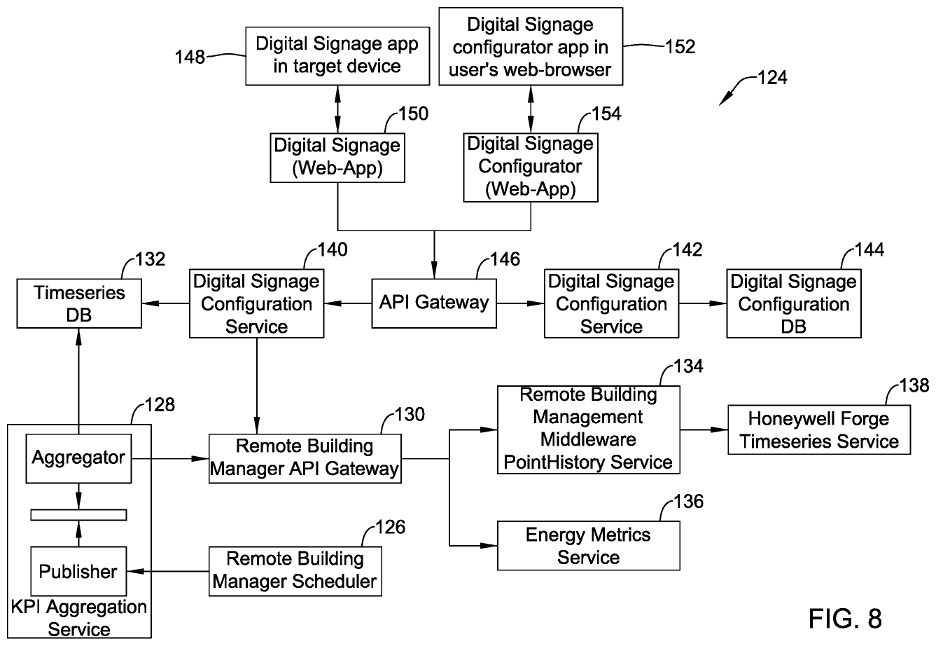

FIG. 8 is a schematic block diagram showing an illustrative digital signage integration architecture 124. A Remote Building Manager Scheduler 126 periodically invokes a KPI Aggregation Service block 128, which in turn communicates with an Remote Building Manager API Gateway 130 and a Timeseries DB (database) 132. The Remote Building Manager API Gateway 130 communicates with an Remote Building Manager Middleware PointHistory Service block 134, an Energy Metrics Service block 136 and the Honeywell Forge Timeseries Service block 138. A Digital Signage Composite Service 140 communicates with both the Timeseries DB 132 and with the Remote Building Manager API Gateway 130. A Digital Signage Configuration Service block 142 communicates with a Digital Signage Configuration DB 144. The Digital Signage Composite Service block 140 and the Digital Signage Configuration Service block 142 communicates with an API Gateway 146. Coming from the top, a target device may include a Digital Signage App 148, which communicates with a Digital Signage Configurator Web App 150. A Digital Signage Configurator App 152 running in a web browser communicates with a Digital Signage Configurator Web App 154. The Digital Signage configurator Web App 154 and the Digital Signage Configurator Web App 150 both communicate with the API Gateway 130.

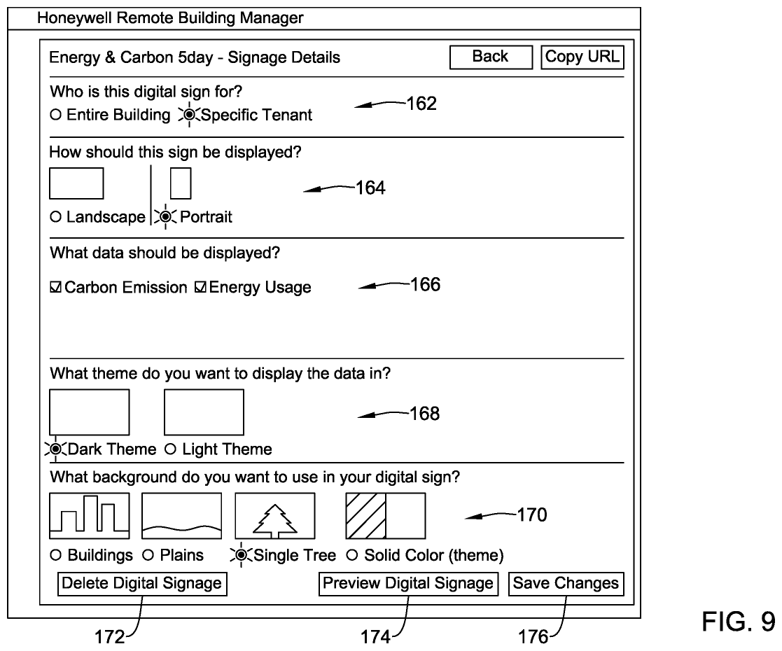

FIG. 9 is a screen shot 160 showing an illustrative digital signature configurator. The screen shot 160 displays a dashboard providing an example of some of the configuration options for configuring the digital signage of a tenant. The dashboard includes a section 162 that allows the user to indicate whether the digital sign is for the entire building, or for a particular tenant. As shown, a specific tenant is selected, and is in fact “Meta Technologies”. A section 164 allows the user to indicate whether the digital sign should be displayed in landscape mode (wider than tall) or in portrait mode (taller than wide). As shown, portrait is selected. A section 166 allows a user to select which data should be displayed. The section 166 provides options for carbon emission and energy usage. Other KPIs may also be available for display. As shown, both carbon emission and energy usage are both selected. A section 168 allows a user to select between a dark theme and a light theme. As shown, the dark theme has been selected. A section 170 allows a user to select between several different backgrounds, including “Buildings”, “Plains”, “Single Tree” and “Solid Color”. As shown, “Single Tree” is selected. The dashboard also includes a Delete Digital Signage button 172 that allows a user to delete the digital signage, a Preview Digital Signage button 174 that allows a user to preview the digital signage, and a SAVE CHANGES button that allows a user to save their changes.

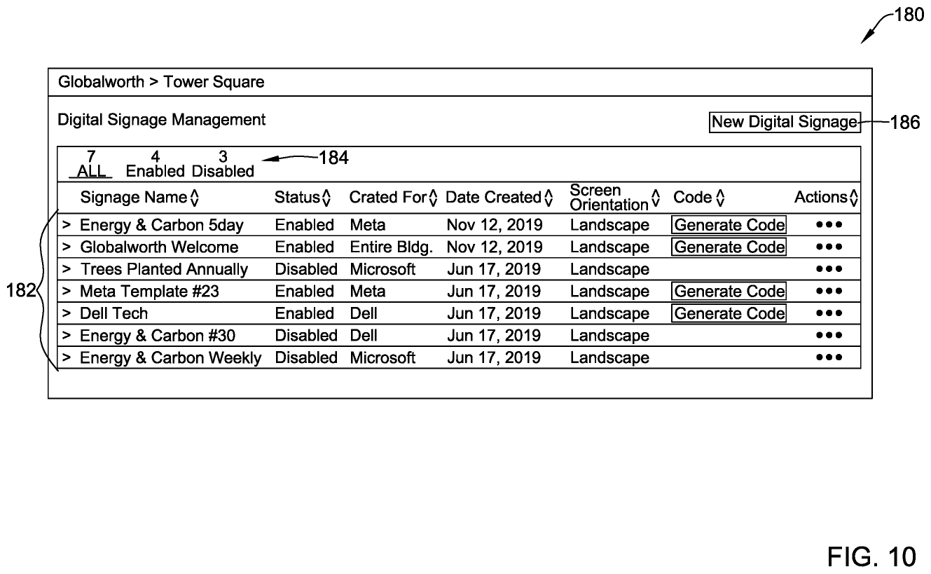

FIG. 10 is a screen shot 180 showing an illustrative digital signature management user interface. The screen shot 180 includes a list 182 of available digital signs. In some instances, the user may be able to toggle between displaying ALL signs, just ENABLED signs or just DISABLED signs, as indicated in section 184. As shown, ALL has been selected. The list 182 includes, for all of the listed digital signs, information including a name of the digital signage, its status, who it was created for, when it was created, and screen orientation. In some instances, there is a “generate code” button for generating a registration code for the corresponding digital signage that has been created. When one of the “generate code” buttons is selected, a registration code for the corresponding digital signage is automatically generated and communicated to a user associated with the corresponding tenant. When that user enters the registration code into the display device in the tenant's space, the corresponding digital signage is identified, retrieved and displayed on the display device. The screen shot 180 also includes a NEW DIGITAL SIGNAGE button 186 that allows a user to create a new digital signage.

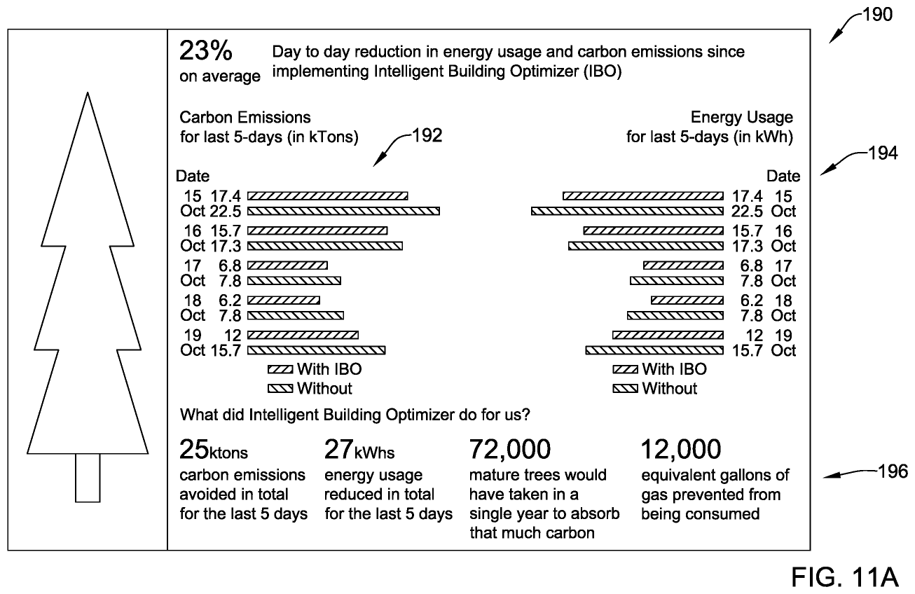

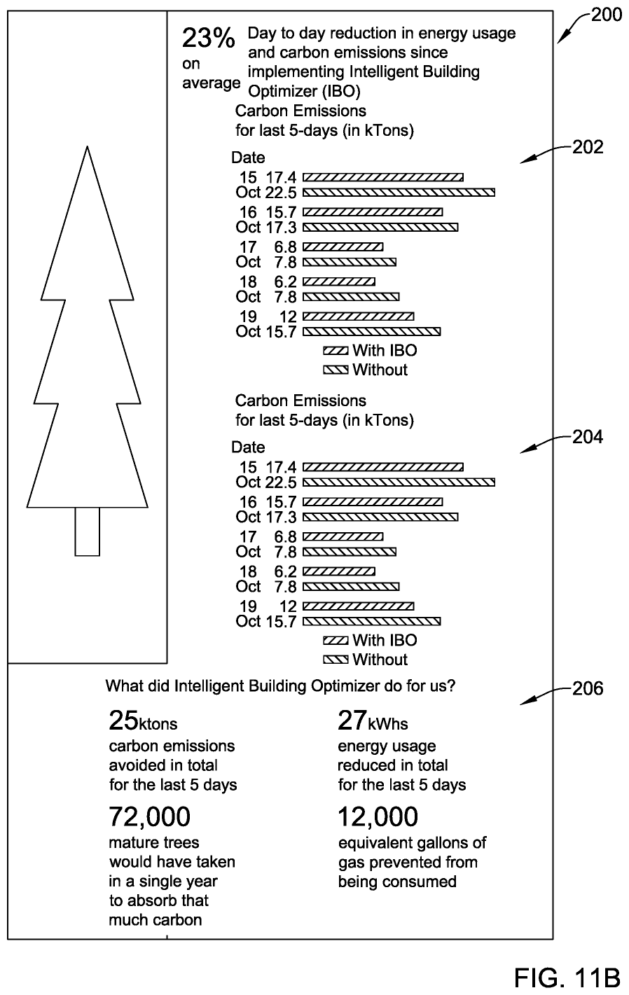

FIGS. 11A and 11B are screen shots showing illustrative digital signs that may be displayed. FIG. 11A shows a screen shot 190 that is displayed in landscape mode while FIG. 11B shows a screen shot 200 that is displayed in portrait mode. The screen shot 190 includes a section 192 displaying carbon emissions performance for the past 5 days and a section 194 displaying energy usage performance for the past 5 days. A section 196 provides a summation of what active energy savings algorithms (e.g. Intelligent Building Optimizer (IBO)) have achieved, including 25 kilotons of carbon emissions avoided, 27 kWhs of energy usage reduced, 72,000 mature trees saved and 12,000 gallons of gas not consumed. FIG. 11B provides the same information, just arranged differently to achieve the portrait mode. The screen shot 200 includes section 202 displaying carbon emissions performance for the past 5 days and a section 204 displaying energy usage performance for the past 5 days. A section 206 provides a summation of what active energy savings algorithms (e.g. Intelligent Building Optimizer (IBO)) have achieved, including 25 kilotons of carbon emissions avoided, 27 kWhs of energy usage reduced, 72,000 mature trees saved and 12,000 gallons of gas not consumed.

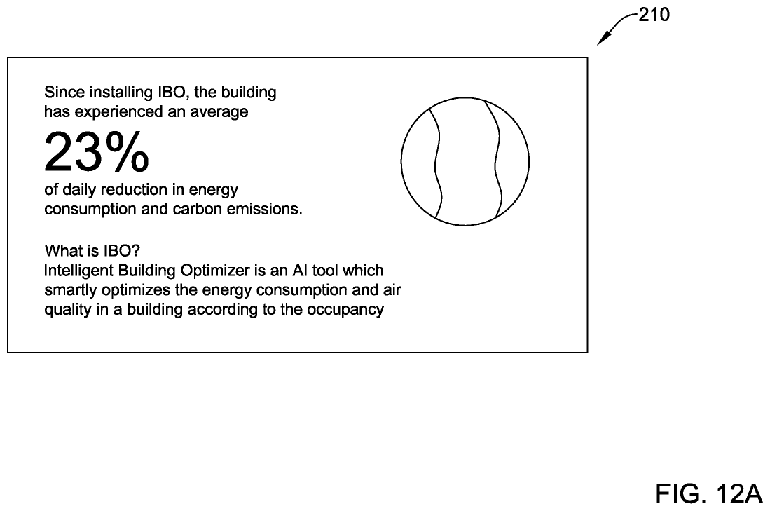

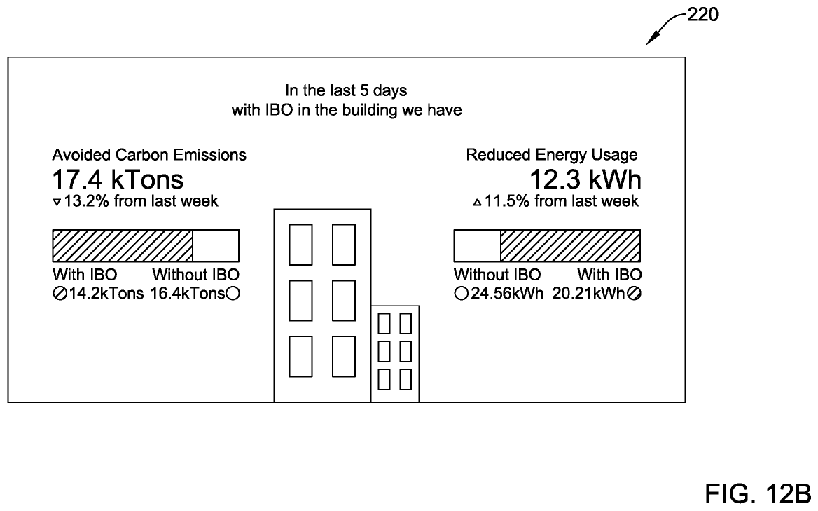

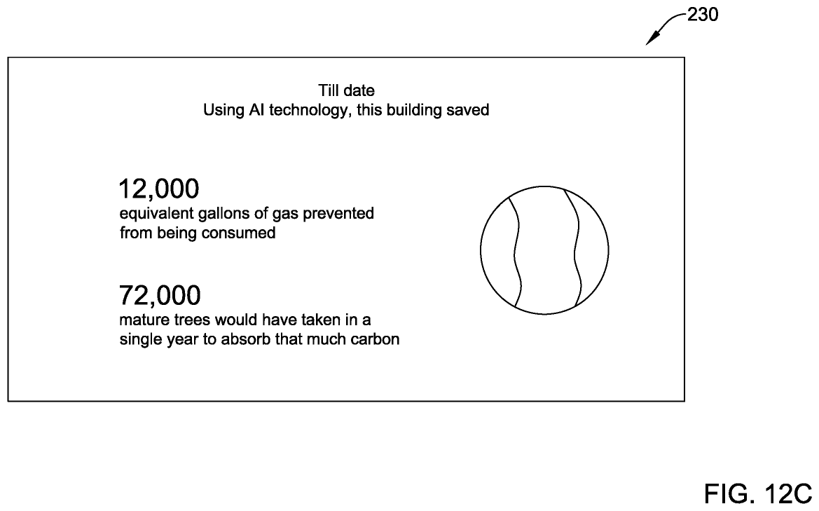

FIGS. 12A, 12b and 12C are screen shots showing illustrative digital signs that may be displayed on a rotating basis (e.g. cycled one after another). For example, a digital sign device may display a screen shot 210 (FIG. 12A) showing that the building has achieved an average 23 percent reduction in energy consumption and carbon emissions since implementing active energy savings algorithms (e.g. Intelligent Building Optimizer (IBO)). A screen shot 220 (FIG. 12B) shows additional details backing up what was shown in FIG. 12A, including numerical data pertaining to avoided carbon emissions (with and without IBO) and reduced energy consumption (with and without IBO). A screen shot 230 (FIG. 12C) displays the performance of IBO in a different way, indicating the number of gallons of gas saved, and the number of mature trees not sacrificed.

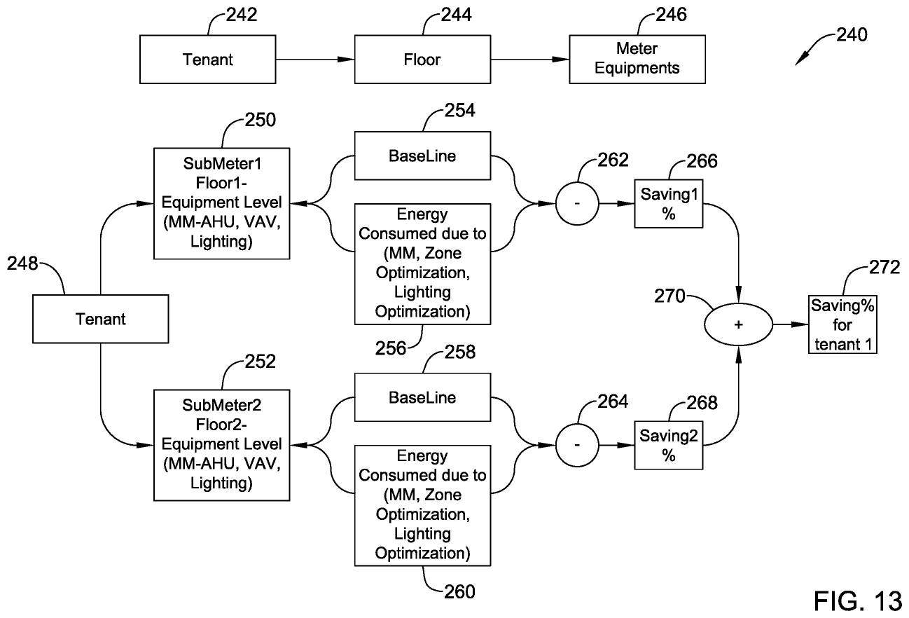

FIG. 13 is a schematic block diagram showing an illustrative tenant level energy segregation process 240. The segregation process 240 occurs at a tenant level 242, a floor level 244 and a metered equipment level 246. Multi-mode energy savings allows a facility manager to optimize the operation of the building in accordance with different optimization modes. For example, the facility manager may choose to operate the building to minimize energy consumption rather than healthy building conditions (e.g. CO2, PM2.5, TVOC, humidity). In another example, such as during a pandemic, the facility manager may choose to operate the building to maximize the healthy building conditions (e.g. CO2, PM2.5, TVOC, humidity) at the expense of energy consumption. In another example, the facility manager may choose to operate the building to provide a balance between energy consumption and healthy building conditions (e.g. CO2, PM2.5, TVOC, humidity). In FIG. 13, for each submeter, a baseline energy consumption is compared with energy consumption after optimization to determine the savings attributed to each meter for that tenant. The savings for each meter for a tenant may be added together to provide a total savings associated with that tenant.

A particular tenant 248 may have equipment on a first floor, as indicated at block 250, and on a second floor, as indicated at block 252. For each, energy consumption is compared with a baseline. For the first floor, the baseline is determined as indicated at block 254 while actual energy consumed is determined as indicated at block 256. For the second floor, the baseline is determined as indicated at block 258 while the actual energy consumed is determined as indicated at block 260. Comparisons are made at difference blocks 262 and 264, respectively, and result in energy savings per floor, as indicated at blocks 266 and 268, respectively. The energy savings per floor are added together at a summation block 270, resulting in a savings percent for the particular tenant, as indicated at block 272.

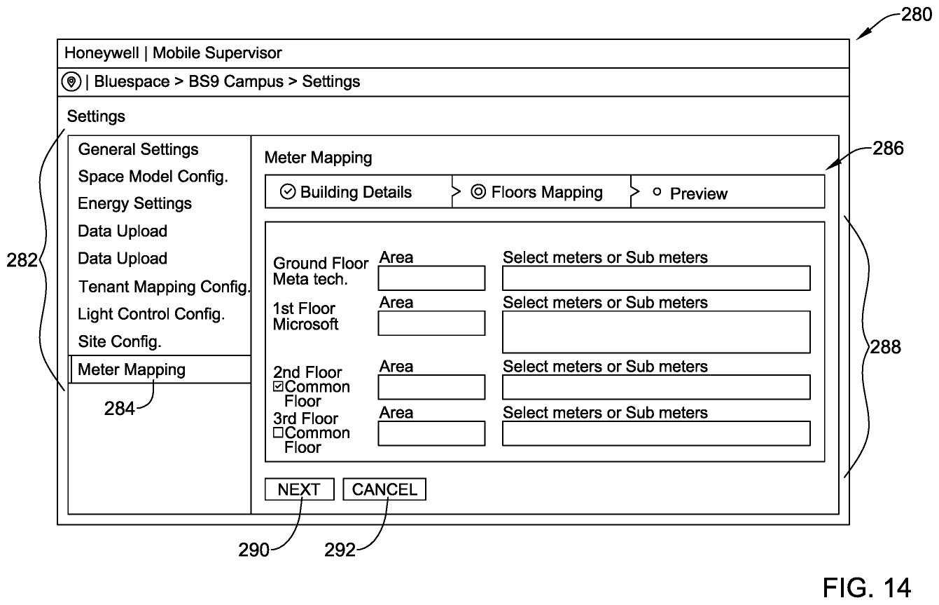

FIG. 14 is a screen shot 280 showing an illustrative meter mapping screen that may be accessed from several different settings, as indicated within a settings section 282. Meter Mapping has been selected, as indicated at 284. A section 286 allows a user to select between Building Details, Floors Mapping, and Preview. A section 288 allows a user to enter square footage values for a number of areas, and to select the corresponding meters that service those particular areas. This dashboard may be used to map the various meters and/or equipment to the different tenant spaces of a building. The screen shot 280 includes a NEXT button 290 that allows a user to move to the next screen, and a CANCEL button 292.

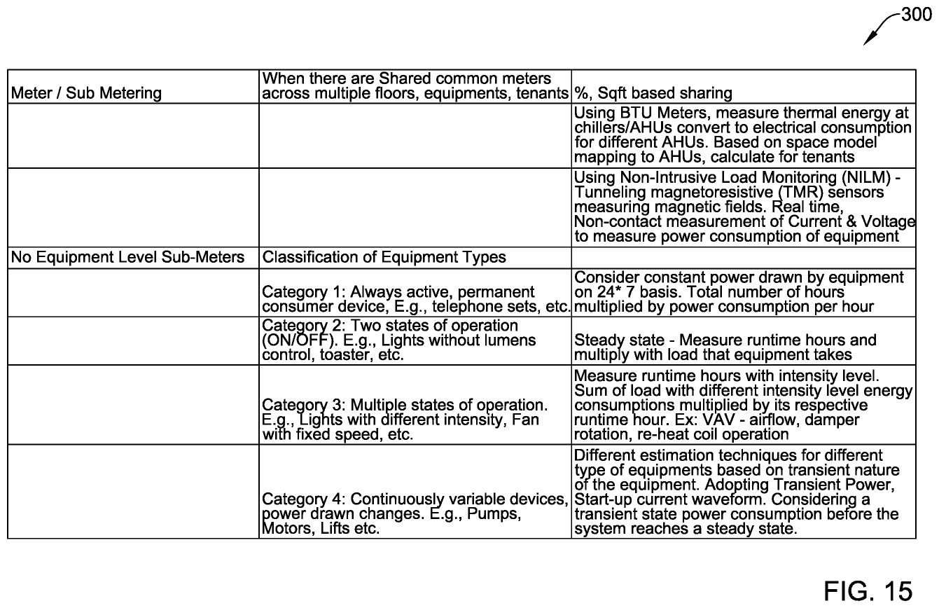

FIG. 15 is a table 300 providing options for determining tenant-level energy consumption. When there are shared meters across multiple floors, equipment and tenants, the amounts assigned to each floor or each tenant may be based on relative square footage, for example. BTU meters may be used to determine energy consumption. In some instances, non-intrusive sensors may be used to obtain current and voltage values. With no meters, four categories of equipment may come into play. For Category 1 equipment, which includes always active devices such as telephones, an assumption may be made that the equipment draws power 24/7. Power consumption may be determined by multiplying the total number of hours by power consumption per hour. For Category 2 equipment, which includes equipment with two states (ON or OFF) such as lights without dimmer switches, runtime hours in the ON state can be measured and multiplied by the energy consumed by that equipment when in the ON state. For Category 3 equipment, which includes equipment with multiple states (high, low, medium), such as 3-way light bulbs or fans with multiple speeds, runtime hours may be tracked for each state, and each may be multiplied by the energy consumed by that equipment when operating in the respective state. The power consumption can then be determined by summing the energy consumed in each state. For Category 4 equipment, which includes continuously variable devices such as pumps and motors, different estimation techniques may be used for different types of equipment. For example, the power consumed may be calculated by multiplying the time spent in each of a plurality of steady state conditions by the power drawn by the device when operating in each steady state condition (e.g. from device specs), and adding in transient power components for each of the periods when the device is transitioning between steady state conditions. The transient power components may be based on a transient model associated with the device.

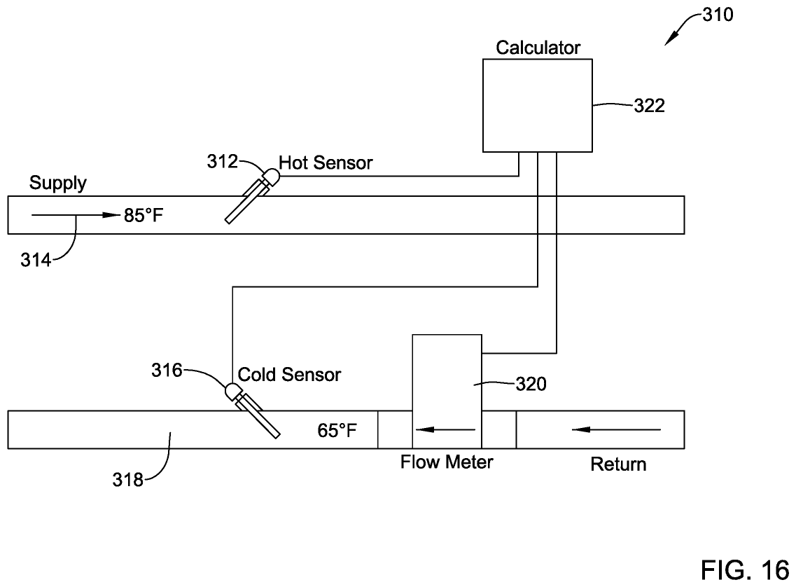

FIG. 16 is a schematic block diagram showing chiller energy sharing between tenants. A chilled water system 310 is schematically shown. A hot sensor 312 is installed in a supply water line 314. A cold sensor 316 is installed in a return line 318. A flow meter 320 is installed in the return line 318. The hot sensor 312, the cold sensor 316 and the flow meter 320 are each coupled with a calculator 322. In method 1, a BTU meter is used. Temperature sensors are installed in supply and return chilled water lines to determine a delta Temperature to an AHU of a building. The calculator 322 receives data from the temperature sensors 312, 316 and the flow meter 320 and determines the thermal energy consumed by the AHU. This energy may be allocated to the tenant space that is serviced by the AHU. In method 2, relative square footage is used to assign fractions of the total energy consumption to a particular tenant space.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A digital sign for use in a building, the digital sign comprising:
a housing;
a display housed by the housing, wherein the display is viewable from outside of the housing;
a wireless interface that supports one or more wireless protocols;
a controller housed by the housing and operatively coupled to the display and the wireless interface, the controller configured to:
identify a current location of the digital sign in the building;
obtain via the wireless interface one or more key performance indicators of the building that are dependent on the current location of the digital sign in the building; and
display on the display the one or more key performance indicators of the building that are dependent on the current location of the digital sign in the building.

2. The digital sign of claim 1, wherein the controller is configured to identify the current location of the digital sign in the building using an indoor positioning system associated with the building.

3. The digital sign of claim 2, wherein the indoor positioning system comprises a plurality of WiFi access points each positioned at a different location in the building, and wherein the wireless interface of the digital sign is configured to communicate with one or more in-range WiFi access points of the plurality of WiFi access points depending on the current location of the digital sign in the building, wherein the current location of the digital sign is identified based at least in part on an identity and location of the one or more in-range WiFi access points.

4. The digital sign of claim 1, wherein the indoor positioning system comprises a plurality of beacons each positioned at a different location in the building, and wherein the wireless interface of the digital sign is configured to communicate with one or more in-range beacons of the plurality of beacons depending on the current location of the digital sign in the building, wherein the current location of the digital sign is identified based at least in part on an identity and location of the one or more in-range beacons.

5. The digital sign of claim 4, wherein the controller is configured to receive a signal strength from each of the in-range beacons, and wherein the controller is configured to triangulate the current location of the digital sign in the building based on the signal strength from each of the in-range beacons and the location of each of the in-range beacons.

6. The digital sign of claim 4, wherein the plurality of beacons comprises a plurality of Bluetooth beacons.

7. The digital sign of claim 1, wherein the controller is configured to obtain the one or more key performance indicators of the building that are dependent on the current location of the digital sign in the building from a remote server.

8. The digital sign of claim 1, wherein the current location of the digital sign corresponds to a particular tenant space of a plurality of tenant spaces in the building, and wherein the one or more key performance indicators that are displayed on the display include one or more of:
a reduction in energy consumption of the particular tenant space relative to a baseline energy consumption for the particular tenant space;
a reduction in energy costs associated with the particular tenant space relative to a baseline energy cost for the particular tenant space; and
a reduction in carbon footprint associated with the particular tenant space relative to a baseline carbon footprint for the particular tenant space.

9. The digital sign of claim 1, wherein the current location of the digital sign corresponds to a particular tenant space of a plurality of tenant spaces in the building, and wherein the one or more key performance indicators that are displayed on the display include one or more of:
a current occupancy count of the particular tenant space; and
a healthy building score for the particular tenant space, wherein the healthy building score is dependent on one or more of the current occupancy count of the particular tenant space, one or more current air quality parameters associated with the particular tenant space, and one or more current behaviors of occupants of the particular tenant space.

10. A method for operating a digital sign device in a building, the method comprising:
identifying each of a plurality of predefined spaces of the building;
storing a digital sign template for each of the plurality of predefined spaces of the building;
dynamically determining a current location of the digital sign device in the building using a location service of the digital sign device;
determining which of the plurality of predefined spaces of the building corresponds to the current location of the digital sign device; and
displaying on the digital sign device the digital sign template that corresponds to the predefined space of the plurality of predefined spaces of the building that is associated with the current location of the digital sign device.

11. The method of claim 10, wherein each digital sign template includes one or more key performance indicators that are selected by a user for the corresponding one of the plurality of predefined spaces of the building.

12. The method of claim 11, wherein a value of the one or more key performance indicators are determined by a remote device and communicated to the digital sign device.

13. The method of claim 11, wherein each of the plurality of predefined spaces of the building corresponds to a corresponding one of a plurality of tenant spaces of the building.

14. The method of claim 13, wherein the one or more key performance indicators that are displayed on the digital sign device includes one or more of:
a reduction in energy consumption of the corresponding tenant space relative to a baseline energy consumption for the corresponding tenant space;
a reduction in energy costs associated with the corresponding tenant space relative to a baseline energy cost for the corresponding tenant space; and
a reduction in carbon footprint associated with the corresponding tenant space relative to a baseline carbon footprint for the corresponding tenant space.

15. The method of claim 13, wherein the one or more key performance indicators that are displayed on the display include one or more of:
a current occupancy count of the corresponding tenant space; and
a healthy building score for the corresponding tenant space, wherein the healthy building score is dependent on one or more of the current occupancy count of the corresponding tenant space, one or more current air quality parameters associated with the corresponding tenant space, and one or more current behaviors of occupants of the corresponding tenant space.

16. The method of claim 10, wherein the digital sign device is configured to communicate with one or more indoor location devices, and based at least in part on the communication with the one or more indoor location devices, determine the current location of the digital sign device in the building.

17. The method of claim 16, wherein the one or more indoor location devices comprises one or more of a WiFi access point and a Bluetooth beacon.

18. A method for operating a digital sign device in a building that includes a plurality of tenant spaces, the method comprising:
placing the digital sign device at a first location in the building;
determining a first current location of the digital sign device in the building that corresponds to the first location based at least in part on communication between the digital sign device and one or more indoor location devices in the building;
determining which of the plurality of tenant spaces of the building corresponds to the first current location of the digital sign device;
displaying on the digital sign device information that corresponds to the tenant space of the plurality of tenant spaces that corresponds to the first current location of the digital sign device;
placing the digital sign device at a second location in the building that is different from the first location;
determining a second current location of the digital sign device in the building based at least in part on communication between the digital sign device and one or more indoor location devices in the building;
determining which of the plurality of tenant spaces of the plurality of tenant spaces corresponds to the second current location of the digital sign device; and
displaying on the digital sign device information that corresponds to the tenant space of the plurality of tenant spaces that corresponds to the second current location of the digital sign device.

19. The method of claim 18, wherein:
the information that corresponds to the tenant space of the plurality of tenant spaces that corresponds to the first current location of the digital sign device includes one or more key performance indicators that are associated with the tenant space of the plurality of tenant spaces that corresponds to the first current location of the digital sign device;
the information that corresponds to the tenant space of the plurality of tenant spaces that corresponds to the second current location of the digital sign device includes one or more key performance indicators that are associated with the tenant space of the plurality of tenant spaces that corresponds to the second current location of the digital sign device; and
wherein the one or more key performance indicators that are associated with the tenant space of the plurality of tenant spaces that corresponds to the first current location of the digital sign device are different from the one or more key performance indicators that are associated with the tenant space of the plurality of tenant spaces that corresponds to the second current location of the digital sign device.

20. The method of claim 19, wherein the one or more key performance indicators that are associated with the tenant space of the plurality of tenant spaces that corresponds to the first current location of the digital sign device and/or to the second current location of the digital sign device includes one or more of:
a reduction in energy consumption of the corresponding tenant space relative to a baseline energy consumption for the corresponding tenant space;
a reduction in energy costs associated with the corresponding tenant space relative to a baseline energy cost for the corresponding tenant space; and
a reduction in carbon footprint associated with the corresponding tenant space relative to a baseline carbon footprint for the corresponding tenant space.
